(19) United States
(12) Patent Application Publication
(10) Pub. No.: US 2005/0257344 A1
(43) Pub. Date: Nov. 24, 2005

(54) Hinge assembly

(76) Inventor: Garry Allen, Nerang (AU)

Correspondence Address: SEYFARTH SHAW LLP, 55 EAST MONROE STREET, SUITE 4200, CHICAGO, IL, 60603-5803, US

(21) Appl. No.: 10/476,907

(22) PCT Filed: May 3, 2002
(86) PCT No.: PCT/AU02/00555

§ 371 Date: Apr. 5, 2004

(30) Foreign Application Priority Data
May 4, 2001 (AU) PR 4768

(51) Int. Cl. E05D 11/06

(52) U.S. Cl. 16/371

(57) ABSTRACT

A hinge assembly for a foldable working platform, said hinge assembly comprising a hinge body (22), first and second hinge arms (24,26) connected to the hinge body (22), the first hinge arm being rotatable relative to the hinge body about a first axis of rotation (28), the second hinge arm being rotatable relative to the hinge body about a second axis of rotation (30), wherein the first and second axes (28,30) are non-coaxial and wherein movement of the hinge arms beyond the open position is restricted by interaction of abutment portions of the first and second hinge arms with respective abutment portions of the hinge body.

### FIELD OF THE INVENTION

The present invention relates to a hinge assembly and especially to a hinge assembly for providing cantilevered support to an otherwise unsupported leaf of a foldable working platform.

### BACKGROUND OF THE INVENTION

Foldable working platforms such as, for example, foldable ironing boards, typically include two leaves hinged together and additional supporting elements in the form of frame, leg or strut elements for supporting each of the two leaves.

There is believed to be a need for a support structure for a foldable working platform which reduces the number of supporting elements, the bulk of the supporting elements, and/or the structural or practical complexity of deploying the leaves and/or supporting elements or which at least provides an alternative to known support structures.

### SUMMARY OF THE INVENTION

According to a first aspect of the present invention, there is provided a hinge assembly for a foldable working platform, said platform comprising first and second leaves, such that in use, when the hinge assembly is in an open position, the first leaf is supported in a substantially horizontal, cantilevered configuration by said second leaf via said hinge assembly so that the first and second leaves form a substantially continuous working platform, and when the hinge is in a closed position, the first leaf is arranged substantially parallel to and adjacent the second leaf, so that the working platform is in a folded configuration,
said hinge assembly comprising:
a hinge body;
first and second hinge arms connected to the hinge body;
the first hinge arm being rotatable relative to the hinge body about a first axis of rotation;
the second hinge arm being rotatable relative to the hinge body about a second axis of rotation;
wherein the first and second axes are non-coaxial; and
wherein movement of the hinge arms beyond the open position is restricted by interaction of abutment portions of the first and second hinge arms with respective abutment portions of the hinge body.

As the first and second axes of rotation are non-coaxial, the first and second hinge arms can be rotated about the hinge body with clearance between one another to a closed position in which the hinge arms are substantially parallel with one another and hence angularly separated by 0°, which is often difficult or impossible with a conventional hinge in which both hinge arms rotate about a common axis of rotation.

The hinge arms may be elongate members of significant length or may be arranged to be attached to such members enabling the members to be folded adjacent one another in the closed position and extended away from one another in the open position. A plurality of the hinge assemblies may be used in unison, for example, a pair of the hinge assemblies may be used to support edges of a table top to facilitate folding of one leaf of the table top atop another leaf of the table top when not in use.

Preferably, the abutment portions comprise complementary arcuate mating surfaces.

Preferably, at least one abutment portion on at least one of the hinge arms or the hinge body comprises a step or ridge portion upstanding from a surface of said hinge arm or hinge body.

Preferably, at least one of a hinge arm or the hinge body includes a body portion adapted to slide into a cavity provided in the other of said hinge arm and said hinge body as the hinge body and hinge arm rotate relative to one another in order to avoid or reduce the creation and/or termination of gaps between the hinge body and the hinge arm during relative rotation.

Preferably, at least one abutment portion comprises a ridge or step upstanding from said body portion.

Preferably, an abutment portion is provided on at least two of an inner side, an outer side and a bottom of at least one of the hinge body or hinge arm.

Preferably, the hinge body includes an attachment portion for attachment of a cover for a working platform, and in use, said attachment portion serves to help secure the cover.

Preferably, said attachment portion is adapted to pass through an aperture in a cover.

Preferably, at least one of said hinge arms includes an attachment portion in order to help secure a cover for a working platform.

Preferably, at least one of said hinge arms includes an attachment portion in order to help secure a cover for a working platform and said attachment portion comprises a guide portion to guide an edge portion of said cover between an attachment point on a working platform and the attachment portion provided on the hinge body.

Preferably, the first and second axes of rotation are substantially horizontal in use and respectively pass through the vertical thicknesses of the first and second hinge arms.

Preferably, when the hinge assembly is in the open position, longitudinal axes of the first and second hinge arms are substantially co-axial with a longitudinal axis of the hinge body.

Preferably, when the hinge assembly is in the closed-position respective longitudinal axes of the first and second hinge arms are substantially parallel, and the longitudinal axes of the first and second hinge arms are substantially perpendicular to a longitudinal axis of the hinge body.

Further aspects of the present invention provide a working platform comprising first and second leaves mutually connected by one or more hinge assemblies in accordance with the first aspect.

A further aspect of the present invention provides an ironing board comprising first and second leaves mutually connected by one or more hinge assemblies in accordance with the first aspect.

In a particularly preferred embodiment of the present invention, a pair of hinge assemblies connect two leaves of the working platform of a folding ironing board. Preferably, the ironing board can be folded approximately centrally of the longitudinal extent of its working platform.

### BRIEF DESCRIPTION OF THE DRAWINGS

Preferred embodiments of the present invention will now be described, by way of example only, with reference to the accompanying drawings, in which:

FIG. 1 is a perspective view of a hinge assembly in a fully open position;

FIGS. 2 to 4 are perspective views of the hinge assembly of FIG. 1 in sequential intermediate positions in movement between a fully open position and a fully closed position;

FIG. 5 is a perspective view of the hinge assembly of FIG. 1 in the fully closed position;

FIG. 6 is a partial perspective view illustrating the hinge assembly of FIG. 1 in the fully open position and supporting a leaf of a two-piece working platform of a folding ironing board;

FIGS. 7 to 9 are partial perspective views of the hinge assembly and working platform of FIG. 6 in sequential intermediate positions in movement between the fully open position and the fully closed position;

FIG. 10 is a partial perspective view of the hinge assembly and working platform of FIG. 6 in the fully closed position;

FIGS. 11 to 13 are perspective views of the hinge assembly of FIG. 1 in positions equivalent to those shown in FIGS. 1, 3 and 5 respectively, illustrating the interaction in use of the hinge assembly with a cloth ironing board cover, during movement between the fully open position and the fully closed position, with the working platform omitted for simplicity;

FIGS. 14a and 14b are perspective views of a variation of a hinge arm;

FIGS. 14c, 14d, 14e and 14f are respectively outer side, bottom, top and end views of the hinge arm of FIGS. 14a and 14b;

FIGS. 14g, 14h and 14i are cross-sectional views corresponding to the section lines G-G, H-H and I-I of FIG. 14d;

FIGS. 15a and 15b are perspective views of a hinge body for use in the embodiment of FIG. 1;

FIGS. 15c, 15d, 15e, 15f and 15g are outer side, bottom, top, inner side, and end views of the hinge body of FIGS. 15a and 15b; and

FIG. 15h is a cross-sectional view on H-H of FIG. 15e.

### DETAILED DESCRIPTION OF THE DRAWINGS

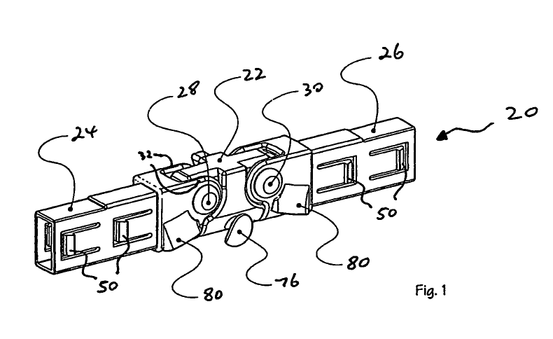

Referring firstly to FIG. 1, the principal elements of a hinge assembly 20 are a hinge body 22, a first hinge arm 24 and a second hinge arm 26. Hinge arms 24 and 26 are pivotally connected to hinge body 22 by first and second hinge pins 28, 30, respectively. The hinge pins 28 and 30 are spaced apart from one another and substantially parallel. The respective axes of rotation of the first and second hinge arms 24, 26 relative to the hinge body 22 are thus non-coaxial.

As illustrated in FIG. 1, the hinge assembly 20 is in a fully open position with the hinge arms 24, 26 extending horizontally away from the hinge body 22 in substantially opposing directions and being separated from one another by an angle of 180°.

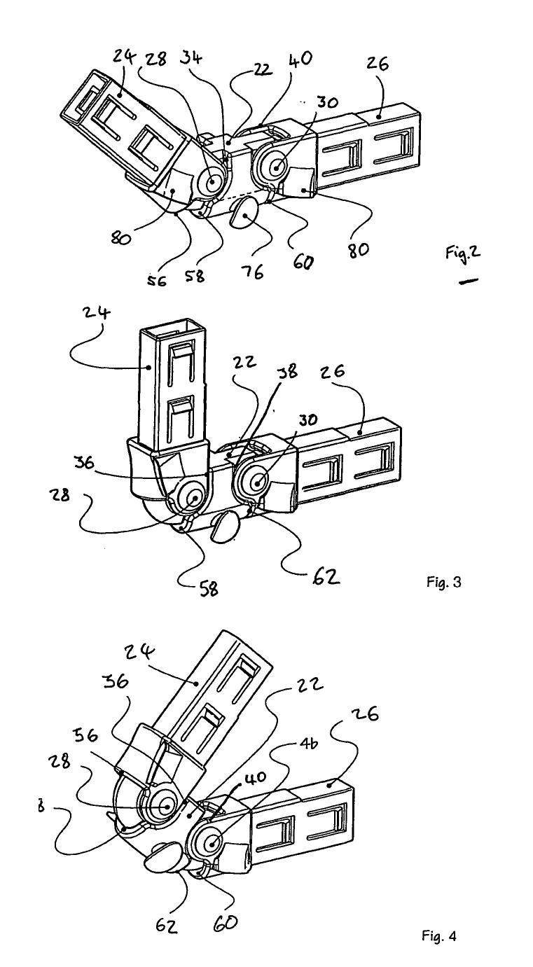

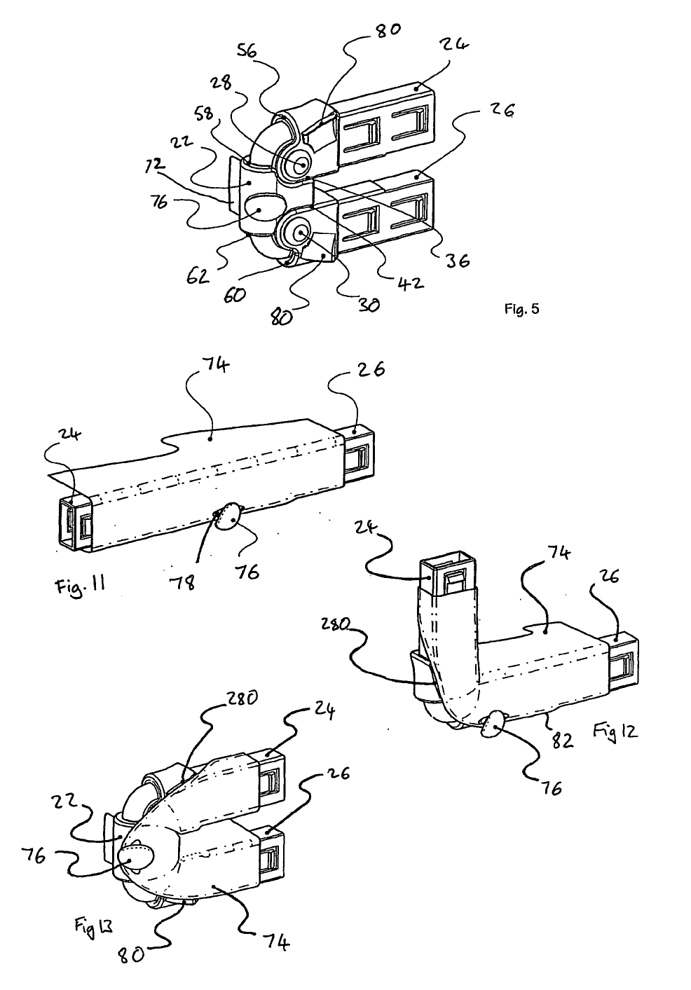

The first hinge arm 24 may be attached to a first leaf of a working platform, and the second hinge arm 26 may be attached to a second leaf of the working platform. As illustrated in the drawings, the first leaf could be supported by the second leaf via the hinge assembly (or a plurality of hinge assemblies) and the second leaf would be supported by external support elements such as frame, leg or strut elements. In movement from the open position illustrated in FIG. 1 to the closed position illustrated in FIG. 5, elements of the hinge assembly 20 rotate relative to each other first about the first hinge pin 28 and subsequently about the second hinge pin 30. Urging the distal end of the first hinge arm 24 upwardly results in its rotation relative to hinge body 22 about the first hinge pin 28 through the position illustrated in FIG. 2. Continued rotation of the first hinge arm 24 results in closed-position mating surfaces 32 of the first hinge arm 24 meeting closed-position mating surfaces 34 of the hinge body 22 at junction 36 at the position illustrated in FIG. 3. At this position, it can be seen that the first hinge arm 24 is generally perpendicular to the hinge body 22.

Further rotation about hinge pin 28 is inhibited by the engagement of the closed-position mating surfaces 32, 36 and continued urging of the first hinge arm 24 causes the hinge body 22 to rotate relative to the second hinge arm 26, about the second hinge pin 30, through the position illustrated in FIG. 4. Continued rotation of hinge body 22 about the second hinge pin 30 results in closed-position mating surfaces 38 of the hinge body 22 meeting closed-position mating surfaces 40 of the second hinge arm 26 at junction 42 at the closed position of the hinge assembly illustrated in FIG. 5. In the closed position, the hinge arms 24 and 26 extend horizontally away from the hinge body 22 substantially parallel to one another, and substantially perpendicular to the hinge body 22.

This illustrated order of relative movement is preferred, but not essential, and may vary, even in one embodiment due to factors such as wear or lubrication of different parts of the hinge assembly.

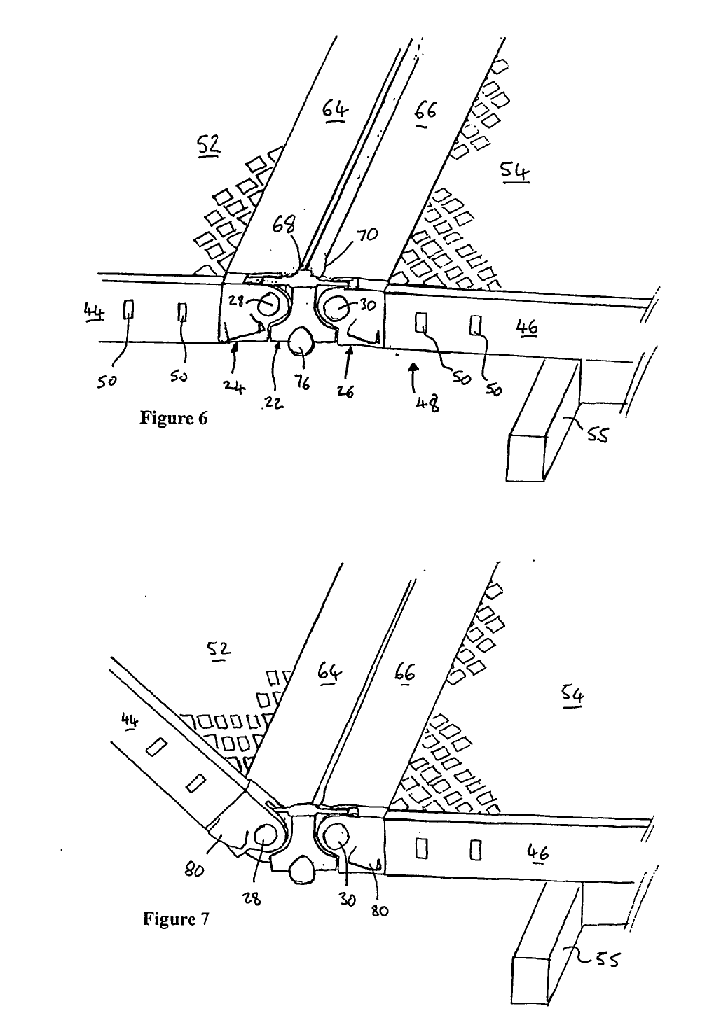

Referring now to FIG. 6, the first and second hinge arms 24, 26 are arranged to be received in respective first and second channels 44, 46 of an ironing board working platform 48 and secured thereto by locking tabs 50 which pop into complimentary slots or apertures in the channels 44 and 46.

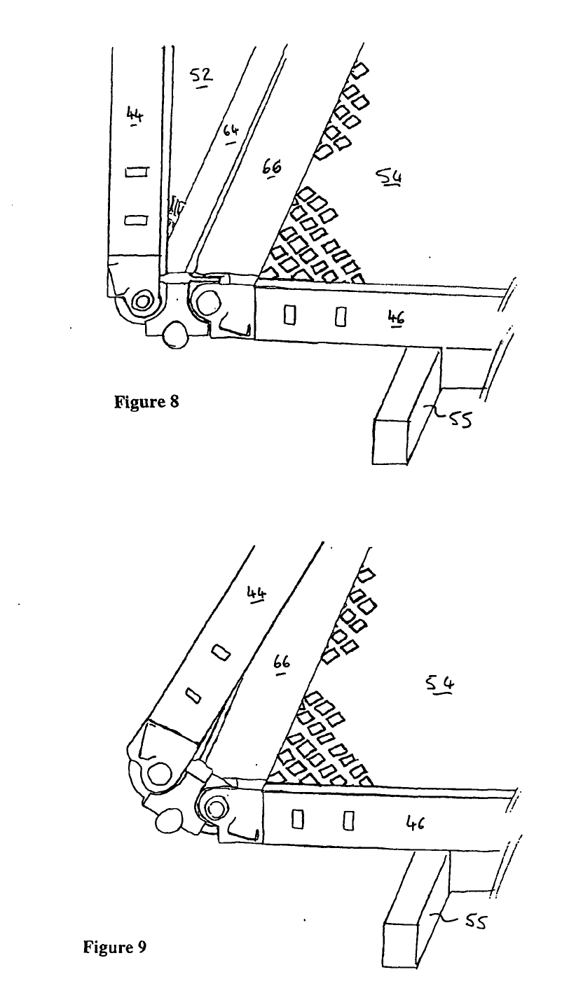

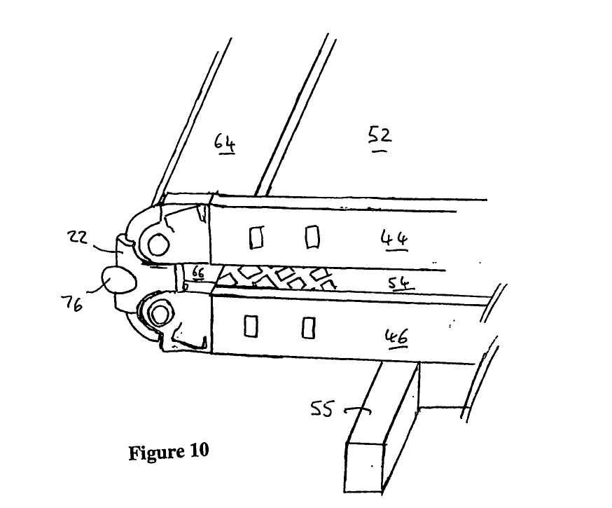

The working platform 48 is formed of first and second leaves 52, 54 which are secured together by a pair of hinge assemblies 20 (only one illustrated). The leaves 52 and 54 are illustrated in a working (open) position in FIG. 6. By urging the first leaf 52, and by the consequent action of the hinge assemblies 20, the first leaf 52 is rotated relative to the second leaf through the positions illustrated in FIGS. 7 to 9 until the hinge assembly is in its closed position and the first leaf 52 is in a storage position, illustrated in FIG. 10.

Only the second leaf 54 of working platform 48 is supported by external support elements 55. In the working position, illustrated in FIG. 6, the first leaf 52 is supported solely by the second leaf via the hinge assemblies 20. In the working (open) position, the first leaf 52 is therefore supported in a cantilevered configuration. Referring back to FIGS. 1 to 5, the support is provided by interaction between two pairs of open-position mating surfaces. A first pair of open-position mating surfaces comprises open-position mating surfaces 56 of the first hinge arm 24 and open-position mating surfaces 58 of the hinge body 22. A second pair of open-position mating surfaces comprises open-position mating surfaces 60 of the second hinge arm 26 and open-position mating surfaces 62 of the hinge body 22. The open-position mating surfaces 56, 58, 60, 62 of each pair abut when the hinge assembly is in the open position, illustrated in FIG. 1. The interaction between the mating surfaces 56, 58, 60, 62 is sufficient to support a working load on the first leaf 52 in the working position of FIG. 6.

The edges 64 and 66 of leaves 52 and 54 respectively are formed with curved lips 68 and 70 respectively which may be guided by leaf guide 72 of hinge body 22 during movement between the positions illustrated in FIGS. 6 and 10, to maintain the pair of hinge assemblies 20 rotating in unison and thereby minimise the tendency of the edges 64 and 66 to twist relative to one another.

In use, the leaves 52 and 54 will typically be covered by a thin sheet of foam (not shown) and a material cover 74 (see FIGS. 11-14). Each hinge body 22 is formed with a cover attachment portion in the form of button 76 which retains the material cover 74 by a button hole 78 which maintains the cover 74 taut in the operating position of FIG. 11 and prevents the cover 74 coming away from leaves 52 and 54 in the storage position, illustrated in FIG. 13. Each hinge arm 24 and 26 is formed with a guide tab 80 which guides movement of an elasticised edge 82 of the material cover 74 during rotation of the hinge assemblies 20.

The main elements of the hinge assembly will now be described in more detail.

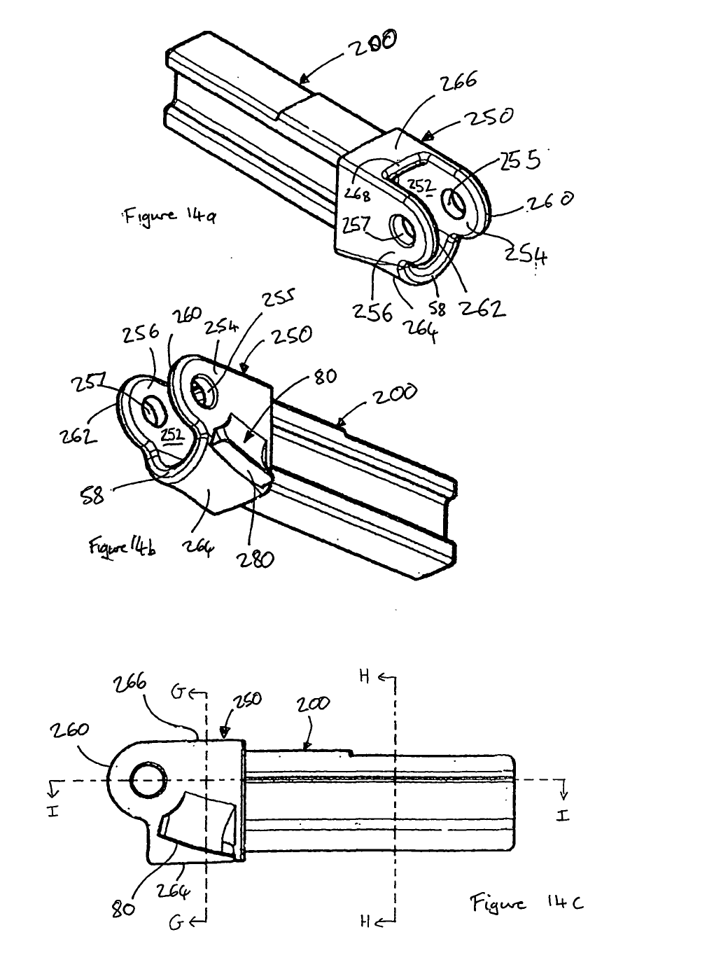

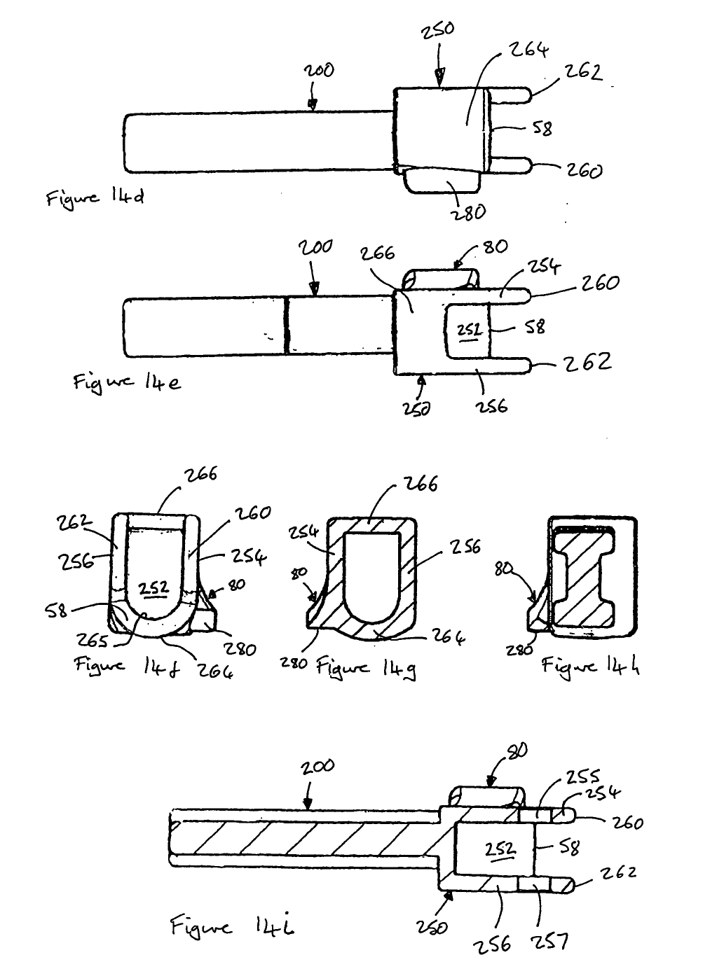

With reference to FIGS. 14a to 14i, the illustrated hinge arm corresponds to, but is slightly different to the second hinge arm 26 of FIGS. 1 to 13 since it is not provided with locking tabs (50 in FIG. 1). However, since the embodiment of FIGS. 14a to 14i has many common features to that of the embodiment of FIGS. 1 to 13, corresponding reference numerals will be used for corresponding features. The hinge arm 26 of FIGS. 14a to 14i has an elongate fitting portion 200 for fitting into a channel of an ironing board working platform, and a connection portion 250 for connection and engagement with the hinge body 22 of a hinge assembly 20. The fitting portion 200 has a rearmost end distal from the connection portion 250 and a foremost end connected to the connection portion 250.

The fitting portion 200 is generally I-shaped in cross-section, as best shown in FIG. 14h. The hinge arm 26 may be considered to have an outer side, which in use, faces away from the working platform, and an inner side which, in use, faces towards the centre of the working platform. On the outer side of the connection portion 250 is located the guide tab 80 which provides a generally downwardly facing guide surface 280 in order to guide movement of an elasticised edge of a material cover (shown in FIGS. 11 to 13). The guide surfaces are inclined and run in a direction which is generally aligned from the bottom (or non-working surface) extreme of the hinge arm towards the button.

The connection portion 250 includes a cavity 252 for receiving an end portion of a hinge body 22, the cavity 252 being defined by opposing side wall portions 254, 256. Each of the opposing wall portions 254, 256 has a respective circular aperture 255, 257 therein for receiving a hinge pin 30 in order to pivotally attach the hinge arm 26 to the hinge body 22. The opposing wall portions 254, 256 have respective front edges 260, 262 which are arcuate and which have a centre of curvature located at the centre of the respective apertures 255, 257. In use, the front edges 260, 262 run close to or bear against corresponding surfaces of the hinge body 22 (described in detail hereafter) in a configuration which helps avoid catching of objects between the hinge arm 26 and the hinge body 22 during operation, and which may provide support for the hinge pins if required.

The opposing wall portions 254, 256 are connected together by a bottom wall portion 264 and a top wall portion 266. As shown in FIG. 14c, the bottom wall portion 264 extends forwardly from the foremost end of the fitting portion 200 to a position directly beneath the centre of the apertures 255, 257. As is best shown in FIGS. 14a, 14b, 14f and 14g the bottom wall is arched downwardly at its foremost part providing an arcuate inner surface 265. The arcuate foremost edge of the bottom wall 264 provides the open-position mating surfaces 60 of the second hinge arm 26.

The top wall 266 is relatively short, extending forwardly from the foremost end of the fitting portion 200 approximately half as far as the bottom wall 264 extends. The top edges of the wall portions 254, 256 provide the closed-position mating surfaces 38 of the second hinge arm. (A foremost edge 268 of the top wall 266 may also provide a closed-position mating surface 38 of the second hinge arm, by engagement with the top surface of the hinge body 22, if required.)

The preferred embodiment of a hinge arm is made from aluminium and may conveniently be formed from two separately formed longitudinal “halves”, so that the finished hinge arm has a longitudinal joint line along its length, approximately half way between the inner and outer sides thereof. Although only one hinge arm 26 is described in detail, and illustrated in FIG. 14, it will be appreciated that the first hinge arm 24 corresponds, but is a mirror image thereof.

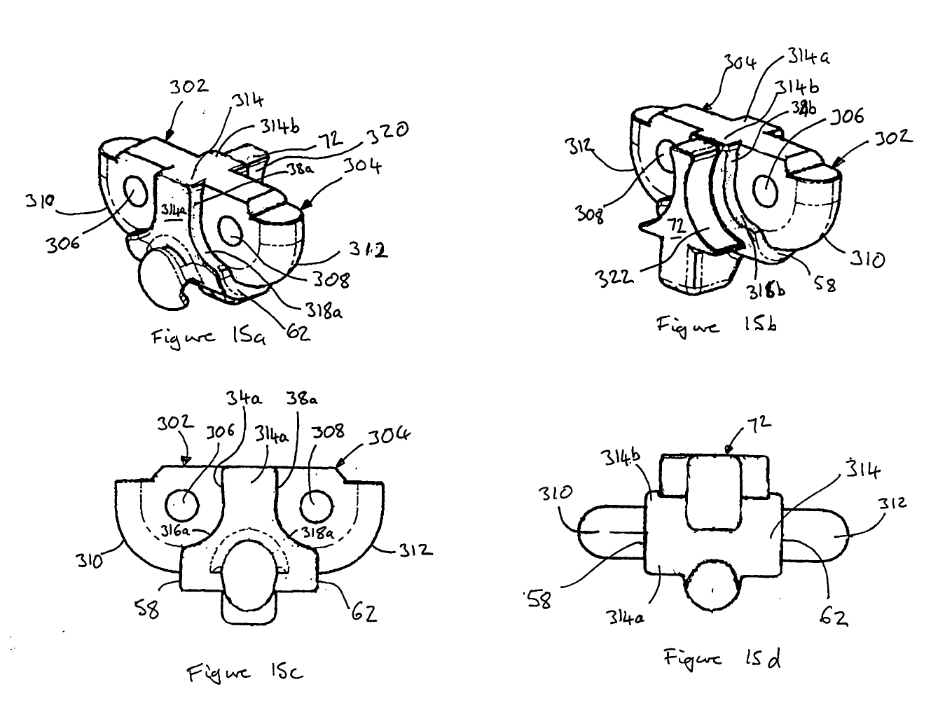

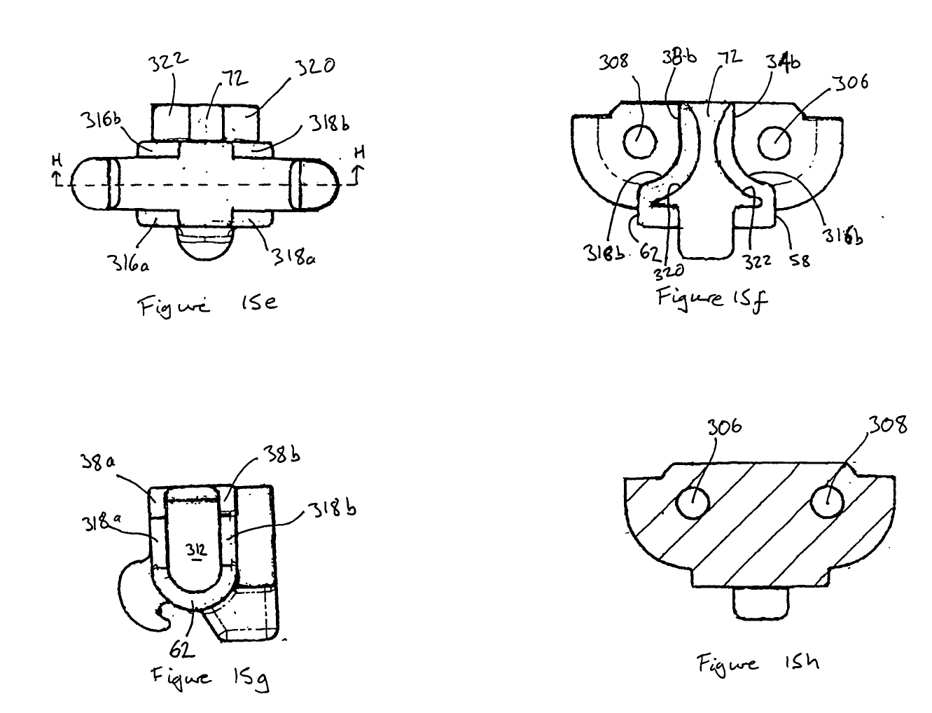

With reference to FIGS. 15a to 15h, the preferred embodiment of the hinge body 22 will now be described in detail.

The hinge body 22 includes first and second hinge body end portions 302, 304 at respective first and second ends thereof. Each end portion 302, 304 is laterally narrow compared to the rest of the hinge body 22 and includes a respective circular aperture 306, 308 therethrough for receiving a respective hinge pin 28, 30 and thereby connecting the hinge body 22 to respective hinge arms 24, 26.

Each end portion 302, 304 has a respective arcuate edge portion 310, 312, being approximately quarter circular, extending from an endmost edge part of the respective end portion to a bottommost edge of the respective end portion, and having the respective apertures 306, 308 as their respective centres of curvature.

The arcuate edge portions 310, 312 have rounded surfaces in the lateral direction of the body end portions 302, 304, so that they can slide neatly into and out of the spaces defined by the arcuate inner surfaces 265 of the hinge arms 24, 26, when the hinge body 22 and hinge arms 24, 26 are rotated relative to each other. This sliding action avoids the creation and termination of gaps, in which objects could get caught, during operation of the hinge assembly.

Intermediate the two hinge body end portions 302, 304 there is a central body portion 314 which has a first side projecting portion 314a projecting to an outer lateral side of the hinge body 22 and a second side projecting portion 314b projecting to an inner lateral side of the hinge body 22. The first and second side portions 314a, 314b of the central body portion 314 meet at the bottom of the hinge body 22 so that the central body portion 314 effectively wraps around the sides and bottom of the hinge body 22.

The projecting central body portion 314 provides a number of step or ridge portions which form narrow mating or bearing surfaces for interaction with surfaces on the hinge arms 24, 26. In this embodiment, the mating or bearing surfaces provided project substantially perpendicular to the adjacent surfaces of the end portions 302, 304 of the hinge body 22.

Because the projecting central body portion 314 extends substantially symmetrically about both sides of the hinge body 22, similar mating or bearing surfaces are provided on the inner and outer sides of the hinge body 22. For convenience only those provided on the outer side will be described in detail below, and the reference numerals used will be suffixed by the letter “a”. Corresponding mating surfaces provided on the inner side of the hinge body 22 are designated in the drawings by the same reference numerals but with the suffix “b” replacing the suffix “a”.

Towards the top of the hinge body (as shown, for example in FIG. 15a) the central body portion is relatively small in longitudinal extent and provides substantially straight, substantially parallel, substantially vertical closed-position mating surfaces 34a, 38a, which are adapted to abut mating surfaces 32, 40 of the hinge arms formed by the top edges of the side wall portions 254, 256.

It is noted for clarity that directional descriptors to the top, bottom and the like of certain elements are used for convenience despite the rotation of those elements in a vertical plane, in use. Such directional descriptors herein refer to the relative directions when the elements are in the orientation shown in FIGS. 1, 6 and 11, that is with the hinge assembly 20 fully open and the working platform in a substantially horizontal configuration, and should be construed accordingly.

The projecting central body portion 314 increases in longitudinal extent as it extends downwards (from the bottom of the closed-position mating surfaces 34a, 38a) to provide arcuate bearing surfaces 316a, 318a which have centres of curvature corresponding to the centres of the apertures 306, 308. The arcuate bearing surfaces 316a, 318a extend from the bottom of the vertical mating surfaces 34a, 38a through a quarter circle to respective points substantially vertically below the centres of the apertures 306, 308.

These arcuate bearing surfaces 316a, 318a (and corresponding 316b, 318b on the inner side of the hinge body 22) are adapted in use to slide against, or close to, the arcuate edges 260, 262 of the hinge arms, as discussed above. Also formed by the central body portion 314 where it passes around the underside of the hinge body 22 and extends between the inner and outer sides of the hinge body 22 are open-position mating surfaces 58, 62. These take the form, as best illustrated in FIGS. 15a, 15b and 15g, of vertically orientated semi-annular surfaces. In use, these open-position mating surfaces 58, 62 are adapted to abut the open-position mating surfaces 56, 60 provided on the hinge arms 24, 26.

On the outer side of the central body portion 314a is provided the button 76.

On the inner side of the central body portion 314b is provided the leaf guide 72 which provides first and second arcuate guide surfaces 320, 322 adapted to bear against edges of the two leaves. The leaf guide 72 is provided in order to guide respective leaves of a working platform and help prevent relative twisting of the two leaves which, in practice, would normally be connected by a pair of hinge assemblies 20.

The hinge body 22 is preferably die cast from aluminium.

It will be appreciated that the hinge assembly 20 described has a number of beneficial features. It allows a working platform to be provided in which only one of the leaves needs to be supported by external support elements, since the externally supported leaf can support the other leaf in cantilevered configuration via the hinge assembly or assemblies 20. This provides convenient compact support, and great ease of use as no deployment of external support elements is required. It is normally preferred to use a pair of hinge assemblies to connect two leaves but in certain applications, for example where the working platform is relatively narrow and provided with a central channel, use of a single hinge assembly might be appropriate. In the fully open position, the described hinge assembly fits entirely within the thickness (or height) of the hinge arms 24, 26 and this is advantageous over the use of hinge assemblies which protrude above or below the hinge arms and the platform. When the hinge assembly is in its closed position, the only part of the hinge assembly exposed at the folded terminus of the working platform is the bottom surface of the hinge body 22, providing a blunt and safe platform end, unlike some other hinge assemblies. Rotation of the hinge arms about two non-coaxial axes of rotation allows first and second leaves to be stored parallel and adjacent each other. Different thicknesses of working platform or working platform cover (for example, foam padding and/or an ironing board cover) can be accommodated by use of different lengths of hinge body 22. The use of snug-fitting arcuate sliding portions on the hinge body 22 and hinge arms 24, 26 provides additional support to the structure (if this is required due to wear and or play in the hinge pins 28, 30) and minimises the likelihood of items being caught in gaps which vary in size as the hinge assembly is operated. The provision of closed-position mating surfaces 32, 34, 38, 40 to keep the hinge arms (or leaves) substantially parallel when the, hinge assemblies are closed reduces the likelihood of items, such as fingers, being damaged by being caught between the leaves as the platform is folded. Although desirable these may not always be necessary, as under some circumstances it may be adequate to allow the leaves of the working surface to contact each other in the closed position.

The provision of a button 76 or other suitable cover retaining means on the hinge body 22 helps to retain the cover in position during folding and unfolding. Provision of guide tabs 80 further help to retain the cover and prevent it from becoming caught in the hinge assembly.

Throughout this specification and the claims, the words “comprise”, “comprises” and “comprising” are used in a non-exclusive sense, except where the context requires otherwise.

It is to be understood that, if any prior art publication is referred to herein, such reference does not constitute an admission that the publication forms a part of the common general knowledge in the art, in Australia or in any other country.

Modifications and improvements may be incorporated without departing from the scope of the present invention.

1. A hinge assembly for a foldable working platform, said platform comprising first and second leaves, such that in use, when the hinge assembly is in an open position, the first leaf is supported in a substantially horizontal, cantilevered configuration by said second leaf via said hinge assembly so that the first and second leaves form a substantially continuous working platform, and when the hinge is in a closed position, the first leaf is arranged substantially parallel to and adjacent the second leaf, so that the working platform is in a folded configuration,
said hinge assembly comprising:
a hinge body;
first and second hinge arms connected to the hinge body;
the first hinge arm being rotatable relative to the hinge body about a first axis of rotation;
the second hinge arm being rotatable relative to the hinge body about a second axis of rotation;
wherein the first and second axes are non-coaxial; and
wherein movement of the hinge arms beyond the open position is restricted by interaction of abutment portions of the first and second hinge arms with respective abutment portions of the hinge body.

2. A hinge assembly as claimed in claim 1, wherein the abutment portions comprise complementary arcuate mating surfaces.

3. A hinge assembly as claimed in claim 1, wherein at least one abutment portion on at least one of the hinge arms or the hinge body comprises a step or ridge portion upstanding from a surface of said hinge arm or hinge body.

4. A hinge assembly as claimed in claim 1, wherein at least one of a hinge arm or the hinge body includes a body portion adapted to slide into a cavity provided in the other of said hinge arm and said hinge body as the hinge body and hinge arm rotate relative to one another in order to avoid or reduce the creation and/or termination of gaps between the hinge body and the hinge arm during relative rotation.

5. A hinge assembly as claimed in claim 4, wherein at least one abutment portion comprises a ridge or step upstanding from said body portion.

6. A hinge assembly as claimed in claim 1, wherein an abutment portion is provided on at least two of an inner side, an outer side and a bottom of at least one of the hinge body or hinge arm.

7. A hinge assembly as claimed in claim 1, wherein the hinge body includes an attachment portion for attachment of a cover for a working platform, and in use, said attachment portion serves to help secure the cover.

8. A hinge assembly as claimed in claim 7, wherein said attachment portion is adapted to pass through an aperture in a cover.

9. A hinge assembly as claimed in claim 1, wherein at least one of said hinge arms includes an attachment portion in order to help secure a cover for a working platform.

10. A hinge assembly as claimed in claim 7, wherein at least one of said hinge arms includes an attachment portion in order to help secure a cover for a working platform and said attachment portion comprises a guide portion to guide an edge portion of said cover between an attachment point on a working platform and the attachment portion provided on the hinge body.

11. A hinge assembly as claimed in claim 1, wherein the first and second axes of rotation are substantially horizontal in use and respectively pass through the vertical thicknesses of the first and second hinge arms.

12. A hinge assembly as claimed in claim 1, wherein when the hinge assembly is in the open position, longitudinal axes of the first and second hinge arms are substantially co-axial with a longitudinal axis of the hinge body.

13. A hinge assembly as claimed in claim 1, wherein when the hinge assembly is in the closed-position respective longitudinal axes of the first and second hinge arms are substantially parallel, and the longitudinal axes of the first and second hinge arms are substantially perpendicular to a longitudinal axis of the hinge body.

14. A foldable working platform comprising at least one hinge assembly as claimed in claim 1.

15. A foldable working platform comprising a plurality of hinge assemblies as claimed in claim 1.

16. An ironing board including a working platform as claimed in claim 14.
